(19) United States
(12) Patent Application Publication
(10) Pub. No.: US 2003/0109968 A1
(43) Pub. Date: Jun. 12, 2003

(54) System and method for monitoring the driving state of a vehicle

(76) Inventors: Ulrich Hessmert, Schwieberdingen (DE); Norbert Polzin, Zaberfeld (DE); Helmut Wandel, Markgroeningen (DE); Thomas Sauter, Remseck (DE); Jost Brachert, Ditzingen (DE)

Correspondence Address: KENYON & KENYON, ONE BROADWAY, NEW YORK, NY, 10004, US

(21) Appl. No.: 10/220,513

(22) PCT Filed: Dec. 22, 2001
(86) PCT No.: PCT/DE01/04909

(30) Foreign Application Priority Data
Dec. 30, 2000 (DE) 100 65 768.0
May 9, 2001 (DE) 101 22 404.4

(51) Int. Cl. G06F 7/00

(52) U.S. Cl. 701/1

(57) ABSTRACT

The present invention relates to a system for monitoring the handling characteristics of a vehicle having a sensor suite (10) measuring the wheel force for ascertaining a wheel force at at least one wheel (12) of the vehicle, and means (14) for processing the ascertained wheel force, a condition of the roadway being detected from a result of the processing. The invention also relates to a method for monitoring the handling characteristics of a vehicle.

The present invention relates to a system for monitoring the driving condition of a vehicle, having a sensor suite measuring the wheel force for ascertaining a wheel force at at least one wheel of the vehicle, and having means for processing the ascertained wheel force. The invention also relates to a method for monitoring the driving condition of a vehicle including the steps: Ascertaining a wheel force at at least one wheel of the vehicle using a sensor suite measuring the wheel force, and processing the ascertained wheel force.

### BACKGROUND INFORMATION

The system of this type and the method of this type are used within the framework of vehicle dynamics controls. For example, they are used in connection with anti-lock braking systems (ABS), traction control systems (TCS) and the electronic stability program (ESP). In this context, it is known to detect the wheel speeds of the individual wheels of a motor vehicle using sensors, and to take the detected wheel speeds into account in the open-loop and/or closed-loop control of the vehicle handling characteristics. Although good results are already being obtained with the known methods and systems, there is an interest in further improving the methods and systems of this type, particularly in light of roadworthiness.

In connection with the generic sensors provided, it is further known that various tire manufacturers are planning the future use of so-called intelligent tires. In that case, new sensors and evaluation circuits may be mounted directly on the tire. The use of such tires allows additional functions, such as the measurement of the torque occurring at the tire transversely and lengthwise with respect to the direction of travel, the tire pressure or the tire temperature. In this connection, tires may be provided, for example, in which magnetized areas or strips having field lines running preferably in the circumferential direction are incorporated in each tire. The magnetization is implemented, for example, sectionally, always in the same direction, but with opposite orientation, i.e., with alternating polarity. The magnetized strips run preferably in the vicinity of the rim flange and in the vicinity of the tire contact area. The detecting elements therefore rotate with the wheel speed. Appropriate sensing devices are preferably body-mounted at two or more different points in the direction of rotation, and in addition, have a different radial distance from the axis of rotation. It is thereby possible to obtain an inner measuring signal and an outer measuring signal. A rotation of the tire may then be detected via the changing polarity of the measuring signal or measuring signals in the circumferential direction. For example, it is possible to calculate the wheel speed from the rolling circumference and the temporal variation of the inner measuring signal and the outer measuring signal.

It has likewise already been suggested to arrange sensors in the wheel bearing; this arrangement may be carried out both in the rotating and in the static part of the wheel bearing. For example, the sensors may be implemented as microsensors in the form of microswitch arrays. Forces and accelerations, as well as the rotational speed of a wheel are measured, for example, by the sensors positioned on the movable part of the wheel bearing. These data are compared to electronically stored base patterns or to data of a substantially identical or similar microsensor which is mounted on the fixed part of the wheel bearing.

Within the scope of the known control systems indicated above, it is furthermore known to draw conclusions about the road condition by evaluating specific measured quantities. For example, wheel speeds and wheel velocities are measured at present for this purpose. Furthermore, the braking pressure at a wheel is estimated, for instance, utilizing vehicle models.

### SUMMARY OF THE INVENTION

The present invention builds on the system of this type, in that a condition of the roadway is detected from a result of the processing. Thus, the condition of the roadway is determined directly from the wheel forces ascertained by the sensor suite. This allows a more reliable detection of the road condition, which may be advantageously utilized within the framework of the known control systems.

The system of the present invention is particularly advantageous because the following conditions are detectable: rough road, μ-split, crushed stone, wetness, icy surface and/or deep snow. Under all these circumstances, vehicles exhibit different handling characteristics, which in addition are dependent on the instantaneous driving condition. Thus, knowledge of the roadway condition may be advantageously utilized for influencing the driving condition.

In one preferred specific embodiment of the system according to the present invention, it is further developed in that the sensor suite measuring the wheel force has tire sensors. The tire sensors described in connection with the related art are particularly suitable, for example, for measuring the vertical force of the wheel, so that driving safety may be improved to a great extent.

However, it may also be useful for the sensor suite measuring the wheel force to have wheel-bearing sensors. For example, vertical forces of the wheel may also be measured using such wheel-bearing sensors, so that the system of the present invention may be implemented in this manner, as well. In this connection, it should be noted as particularly advantageous that greatly varying sensor suites which measure wheel forces may be modified within the meaning of the present invention.

In a further preferred specific embodiment of the system according to the present invention, it is further developed in that the circumferential force of the tire is ascertainable from the measurement of the deformation in the tangential direction by a tire sensor, using a characteristic curve between deformation in the tangential direction and the circumferential force, and that a braking pressure may be ascertained from the circumferential force. The vertical and circumferential forces of the tire change as a function of the roadway subgrade. Since the tire deforms accordingly as a function of these forces, it is ultimately possible to determine the forces from the signals of the sensor suite measuring the wheel force. The circumferential force of the respective tire is determined by the measurement of the deformation of the tire, equipped with a tire sensor, in the tangential direction. This is carried out using a characteristic curve, stored in a memory unit, which describes the connection between deformation and circumferential force. From this, it is then possible to determine the braking pressure.

It may advantageously be provided that, when using a traction control system (TCS), given a one-sided control and a braking-pressure difference between the controlled side and the uncontrolled side of more than 40 bar, a μ-split surface is recognized. Such a pressure difference in the case of a rear-wheel drive vehicle, assuming that only one brake-control memory of the braking-torque control is set, may be used as a criterion that a μ-split surface is accurately detected.

It may likewise be provided within the scope of the system according to the present invention that, from the dynamics of changing vertical wheel forces and simultaneous consideration of wheel speed and wheel acceleration, a rough road is accurately detected. A rough-road detection or a roadway with ties may thus be determined, given approximately constant engine torque.

In one particularly preferred further development of the system according to the present invention, the detected condition of the roadway is converted into a roadway-condition signal, and the roadway-condition signal is utilized by an open-loop and/or closed-loop control for influencing the handling characteristics of the vehicle. In this way, it is possible, for example, to improve the algorithms of TCS or ABS. This may be accomplished, for example, by selective activation of certain program parts in the algorithm like, for example, pressure-maintaining functions in the case of TCS on rough road, or by opposite-phase pressure build-up and pressure reduction, respectively, for vibration damping on rough road.

The present invention builds on the method of the species, in that a condition of the roadway is detected from a result of the processing. Thus, the condition of the roadway is determined directly from the wheel forces ascertained by the sensor suite. This allows a more reliable detection of the road condition, which may be advantageously utilized within the framework of the known control systems.

The method of the present invention is particularly advantageous because the following conditions are detectable: rough road, μ-split, crushed stone, wetness, icy surface and/or deep snow. Under all these circumstances, vehicles exhibit different handling characteristics, which in addition are dependent on the instantaneous driving condition. Thus, knowledge of the roadway condition may be advantageously utilized for influencing the driving condition.

In one preferred specific embodiment of the method according to the present invention, it is further developed in that the sensor suite measuring the wheel force uses tire sensors. The tire sensors described in connection with the related art are particularly suitable, for example, for measuring the vertical force of the wheel, so that driving safety may be improved to a great extent.

However, it may also be useful for the sensor suite measuring the wheel force to use wheel-bearing sensors. For example, vertical forces of the wheel may also be measured using such wheel-bearing sensors, so that the method of the present invention may be implemented in this manner, as well. In this connection, it should be noted as particularly advantageous that greatly varying sensor suites which measure wheel forces may be modified within the meaning of the present invention.

In a further preferred specific embodiment of the method according to the present invention, it is further developed in that the circumferential force of the tire is ascertained from the measurement of the deformation in the tangential direction by a tire sensor, using a characteristic curve between deformation in the tangential direction and the circumferential force, and that a braking pressure is ascertained from the circumferential force. The vertical and circumferential forces of the tire change as a function of the roadway subgrade. Since the tire deforms accordingly as a function of these forces, it is ultimately possible to determine the forces from the signals of the sensor suite measuring the wheel force. The circumferential force of the respective tire is determined by the measurement of the deformation of the tire, equipped with a tire sensor, in the tangential direction. This is carried out using a characteristic curve, stored in a memory unit, which describes the connection between deformation and circumferential force. From this, it is then possible to determine the braking pressure.

It may advantageously be provided that, when using a traction control system (TCS), given a one-sided control and a braking-pressure difference between the controlled side and the uncontrolled side of more than 40 bar, a μ-split surface is recognized. Such a pressure difference in the case of a rear-wheel drive vehicle, assuming that only one brake-control memory of the braking-torque control is set, may be used as a criterion that a μ-split is accurately detected.

It may likewise be provided within the scope of the method according to the present invention that, from the dynamics of changing vertical wheel forces and simultaneous consideration of wheel speed and wheel acceleration, a rough road is accurately detected. A rough-road detection or a roadway with ties may thus be determined, given approximately constant engine torque.

In one particularly preferred further development of the method according to the present invention, the detected condition of the roadway is converted into a roadway-condition signal, and the roadway-condition signal is utilized by an open-loop and/or closed-loop control for influencing the handling characteristics of the vehicle. In this way, it is possible, for example, to improve the algorithms of TCS or ABS. This may be accomplished, for example, by selective activation of certain program parts in the algorithm like, for example, pressure-maintaining functions in the case of TCS on rough road, or by opposite-phase pressure build-up and pressure reduction, respectively, for vibration damping on rough road.

The present invention is based on the finding that it is possible to obtain reliable information about the roadway present at the moment based on the measurement of wheel forces. Known control systems, such as ABS, TCS and ESP, are able to advantageously improve their control based on this information.

### BRIEF DESCRIPTION OF THE DRAWING

The present invention shall now be clarified in terms of preferred specific embodiments by way of example, with reference to the accompanying drawing, in which:

FIG. 1 shows a block diagram of a system according to the present invention;

FIG. 2 shows a flowchart of a method according to the present invention;

FIG. 3 shows a part of a tire equipped with a tire side-wall sensor; and

FIG. 4 shows exemplary signal patterns of the tire side-wall sensor depicted in FIG. 3.

### DESCRIPTION OF THE EXEMPLARY EMBODIMENTS

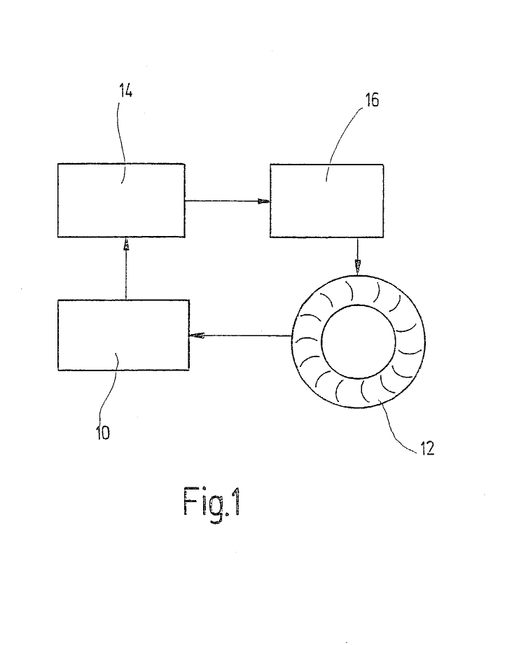

FIG. 1 shows a block diagram of a system according to the present invention. A sensor suite 10 is allocated to a wheel 12, wheel 12 depicted being shown as representative for the wheels of a vehicle. Sensor suite 10 is connected to a device 14 for processing signals. Device 14 is connected to a control 16. This control 16 is in turn allocated to wheel 12.

Sensor suite 10 measures the wheel force of wheel 12. The measuring results yielded therefrom are transmitted to device 14 for processing the measuring results. For example, in device 14, a circumferential force is ascertained from a measured deformation in the tangential direction. This may be accomplished by using a characteristic curve stored in a memory unit. Further, the braking pressure may be ascertained from the circumferential force. Ongoing, a signal which represents a specific roadway condition as a function of the measured values may then be generated in device 14. This signal may then be passed over to a control 16, so that influence may be exerted on wheel 12 as a function of the signal.

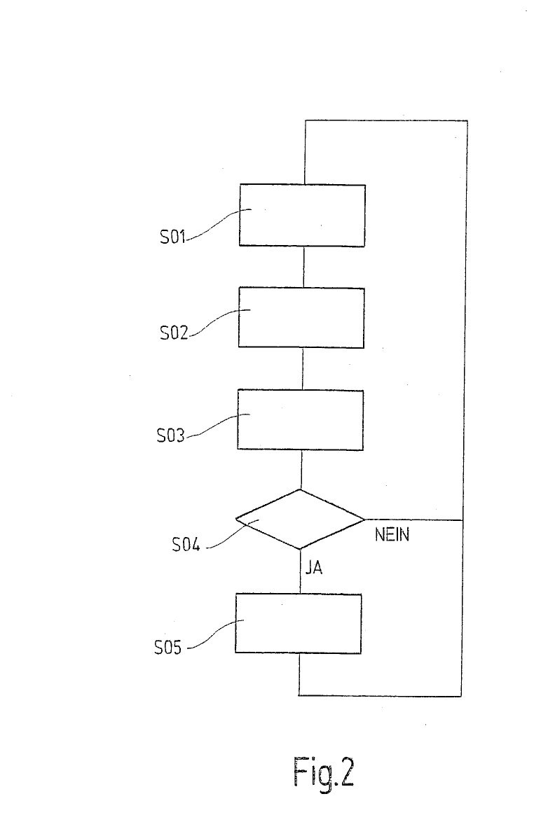

FIG. 2 shows a flowchart of a method within the framework of the present invention, in particular a μ-slippage detection being depicted. First of all, the meaning of the individual steps is indicated:

S01: Measurement of a deformation in the tangential direction of a tire.

S02: Ascertainment of a circumferential force of the tire.

S03: Ascertainment of a braking pressure allocated to the tire.

S04: Braking-pressure difference between controlled vehicle side and uncontrolled vehicle side>40 bar?

S05: Recognition of μ-split.

The method sequence shown in FIG. 2 may be carried out in this or a similar manner in a rear-wheel drive vehicle, the detection of μ-split taking place in the case when a one-sided control is present, that is to say, only one braking-control memory of the braking-torque control is set.

In step S01, a deformation of a tire in the tangential direction is measured.

From this deformation, a circumferential force is ascertained in step S02. This is carried out using a characteristic curve, stored in a memory unit, which indicates the connection between the deformation in the tangential direction and the circumferential force.

The braking pressure is determined therefrom in step S03.

Step S04 now checks whether the braking-pressure difference between the controlled side of the motor vehicle and the uncontrolled side of the motor vehicle is greater than 40 bar. If this is not the case, then a μ-split surface is not recognized.

However, if the minimum value of the braking-pressure difference checked in step S04 is present, then a μ-split surface is recognized in step S05.

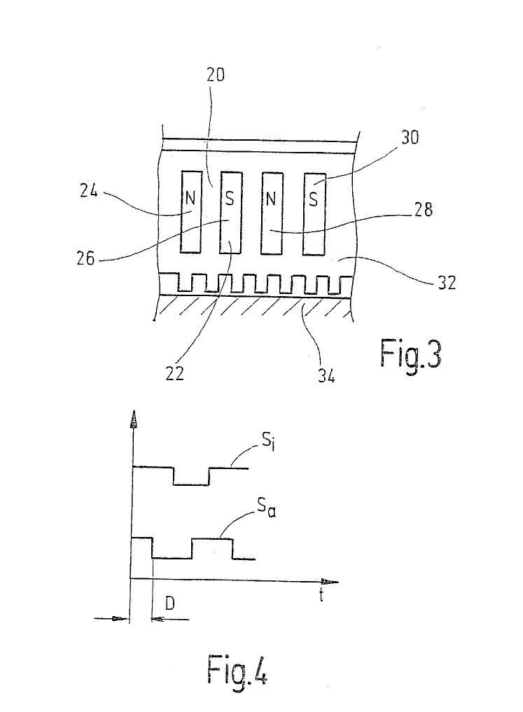

FIG. 3 shows a cut-away portion of a tire 32 having a tire/side-wall sensor suite 20, 22, 24, 26, 28, 30. It includes two sensors 20, 22 which are body-mounted at two different points in the direction of rotation. Furthermore, sensors 20, 22 have a different radial distance from the axis of rotation of the wheel. The side wall of tire 32 is provided with a plurality of detecting elements 24, 26, 28, 30 which have alternating magnetic polarity.

FIG. 4 shows signal patterns Sᵢ and Sₐ of sensor 20 according to FIG. 3 arranged inside, and of sensor 22 according to FIG. 3 arranged outside. A rotation of the tire is detected via the changing polarity of the measuring signals. For example, the wheel speed may be calculated from the rolling circumference of the temporal variation of signals Sᵢ and Sₐ. Torsions of the tire may be ascertained by phase shifts between the signals, and thus, for example, wheel forces may be measured directly. Within the scope of the present invention, it is particularly advantageous if the vertical force of tire 32 on road 34 according to FIG. 3 can be ascertained, since from this vertical force, conclusions can be drawn in a manner according to the invention about the functioning of the shock absorber.

The preceding description of the exemplary embodiments according to the present invention serves only for illustrative purposes, and not for the purpose of limiting the invention. Various changes and modifications are possible within the framework of the invention, without departing from the scope of the invention and its equivalents.

What is claimed is:

1. A system for monitoring the handling characteristics of a vehicle, comprising
a sensor suite (10) measuring the wheel force, for ascertaining a wheel force at at least one wheel (12) of the vehicle, and
means (14) for processing the ascertained wheel force,
wherein a condition of the roadway is detected from a result of the processing.

2. The system as recited in claim 1,
wherein the conditions rough road, μ-split, crushed stone, wetness, icy surface and/or deep snow are detectable.

3. The system as recited in claim 1 or 2,
wherein the sensor suite (10) measuring the wheel force has tire sensors.

4. The system as recited in one of the preceding claims,
wherein the sensor suite (10) measuring the wheel force has wheel-bearing sensors.

5. The system as recited in one of the preceding claims,
wherein
the circumferential force of the tire is ascertainable from the measurement of the deformation in the tangential direction by a tire sensor, using a characteristic curve between deformation in the tangential direction and circumferential force, and
a braking pressure is ascertainable from the circumferential force.

6. The system as recited in one of the preceding claims,
wherein when using a traction control system (TCS), given a one-sided control and a braking-pressure difference between the controlled side and the uncontrolled side of more than approximately 40 bar, a μ-split surface is recognized.

7. The system as recited in one of the preceding claims,
wherein given essentially constant engine torque, a rough road is accurately recognized from the dynamics of changing vertical wheel forces and simultaneous consideration of wheel speed and wheel acceleration.

8. The system as recited in one of the preceding claims, wherein
the detected condition of the roadway is converted into a roadway-condition signal, and
the roadway-condition signal is utilized by an open-loop and/or a closed loop control (16) for influencing the handling characteristics of the vehicle.

9. A method for monitoring the handling characteristics of a vehicle, having the steps:
ascertaining a wheel force at at least one wheel (12) of the vehicle using a sensor suite measuring the wheel force, and
processing the ascertained wheel force,
wherein a condition of the roadway is detected from a result of the processing.

10. The method as recited in claim 9,
wherein the conditions rough road, μ-split, crushed stone, wetness, icy surface and/or deep snow are recognized.

11. The method as recited in claim 9 or 10,
wherein the sensor suite (10) measuring the wheel force uses tire sensors.

12. The method as recited in one of claims 9 through 11,
wherein the sensor suite (10) measuring the wheel force uses wheel-bearing sensors.

13. The method as recited in one of claims 9 through 12,
wherein
the circumferential force of the tire is ascertained from the measurement of the deformation in the tangential direction by a tire sensor, using a characteristic curve between deformation in the tangential direction and circumferential force, and
a braking pressure is ascertained from the circumferential force.

14. The method as recited in one of claims 9 through 13,
wherein when using a traction control system (TCS), given a one-sided control and a braking-pressure difference between the controlled side and the uncontrolled side of more than approximately 40 bar, a μ-split surface is recognized.

15. The method as recited in one of claims 9 through 14,
wherein given essentially constant engine torque, a rough road is accurately recognized from the dynamics of changing vertical wheel forces and simultaneous consideration of wheel speed and wheel acceleration.

16. The method as recited in one of claims 9 through 15,
wherein
the detected condition of the roadway is converted into a roadway-condition signal, and
the roadway-condition signal is utilized by an open-loop and/or a closed loop control for influencing the handling characteristics of the vehicle.

17. A system for the open-loop and/or closed-loop control of the handling characteristics of a motor vehicle having at least one tire and/or one wheel, a force sensor being mounted in the tire and/or on the wheel, particularly on the wheel bearing, and a roadway-condition signal, representing the condition of the roadway, being ascertained as a function of the output signals of the force sensor, and this roadway-condition signal being utilized for the open-loop and/or closed-loop control of the handling characteristics.
